(19) United States
(12) Patent Application Publication
(10) Pub. No.: US 2025/0211987 A1
(43) Pub. Date: Jun. 26, 2025

(54) SECURE ACCESS POINT AUTHENTICATION CREDENTIAL GENERATION IN A MOBILE DEVICE

(71) Applicant: Charter Communications Operating, LLC, St. Louis, MO (US)

(72) Inventors: Eric John Jumper, JR., Colorado Springs, CO (US); Erik Anderson, Aurora, CO (US); James Simonelli, Denver, CO (US); Kyle Lane Davis, New York, NY (US); Erik Olof Stenflo, Boulder, CO (US)

(21) Appl. No.: 18/390,445

(22) Filed: Dec. 20, 2023

(51) Int. Cl. H04W 12/06; H04W 12/041; H04W 12/0431; H04W 76/10

(52) U.S. Cl. CPC H04W 12/068; H04W 12/041; H04W 12/0431; H04W 76/10

(57) ABSTRACT

A mobile device establishes a secure channel protected via encryption with a computing system. The mobile device receives, from the computing system via the secure channel, encrypted Wi-Fi authentication credentials for a Wi-Fi access point that is associated with the mobile device and that implements a network. The mobile device decrypts the encrypted Wi-Fi authentication credentials to generate decrypted Wi-Fi authentication credentials. The mobile device generates, based on the decrypted Wi-Fi authentication credentials, network information to enable the mobile device to authenticate to the Wi-Fi access point without user input and thereby connect to the network.

### BACKGROUND

A mobile device with cellular capabilities may also be capable of communicating with a Wi-Fi access point if the mobile device has the appropriate Wi-Fi authentication credentials.

### SUMMARY

The examples disclosed herein implement secure access point authentication credential generation in a mobile device.

In one implementation a method is provided. The method includes establishing, by a mobile device with a computing system, a secure channel protected via encryption. The method further includes receiving, by the mobile device from the computing system via the secure channel, encrypted Wi-Fi authentication credentials for a Wi-Fi access point that is associated with the mobile device and that implements a network. The method further includes decrypting, by the mobile device, the encrypted Wi-Fi authentication credentials to generate decrypted Wi-Fi authentication credentials. The method further includes generating, by the mobile device based on the decrypted Wi-Fi authentication credentials, network information to enable the mobile device to authenticate to the Wi-Fi access point without user input and thereby connect to the network.

In another implementation a mobile device is provided. The mobile device includes a memory and a processor device communicatively coupled to the memory and operable to establish, with a computing system, a secure channel protected via encryption. The processor device is further to receive, from the computing system via the secure channel, encrypted Wi-Fi authentication credentials for a Wi-Fi access point that is associated with the mobile device. The processor device is further to decrypt the encrypted Wi-Fi authentication credentials to generate decrypted Wi-Fi authentication credentials. The processor device is further to generate, based on the decrypted Wi-Fi authentication credentials, network information to enable the mobile device to authenticate to the Wi-Fi access point without user input and thereby connect to the Wi-Fi access point.

In another implementation a computing system is provided. The computing system includes one or more computing devices operable to establish, with a mobile device, a secure channel protected via encryption. The one or more computing devices are further operable to receive, from the mobile device via the secure channel, a request for Wi-Fi authentication credentials for a Wi-Fi access point that is associated with the mobile device. The one or more computing devices are further operable to send, to the mobile device via the secure channel, encrypted Wi-Fi authentication credentials for the Wi-Fi access point.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which secure access point authentication credential generation in a mobile device can be practiced according to some examples;

FIG. 2 is a flowchart of a method for secure access point authentication credential generation in a mobile device according to some examples;

FIG. 3 is a flowchart of a method for secure access point authentication credential generation in a mobile device from the perspective of a computing system according to some examples;

FIGS. 4A-4E are sequence diagrams illustrating messages communicated between and actions taken by components illustrated in FIG. 1 to implement secure access point authentication credential generation in a mobile device according to some examples; and

FIG. 5 is a block diagram of a mobile device suitable for implementing examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A wireless access point may require authentication credentials from a mobile device prior to allowing the mobile device to connect to the wireless access point. Many mobile devices today automatically continuously scan the relevant frequencies for SSID broadcasts and if an SSID broadcast is identified, present on a display of the mobile device a user interface control that the user may select to begin the authentication process. The user typically provides a password and, if the password is correct, the access point allows the mobile device to connect to the mobile device and obtain services, such as, by way of non-limiting example, Internet access, via the access point. Alternatively, an access point my not broadcast an SSID but may accept a connection from a mobile device that specifically requests to join an SSID offered by the access point and provides the appropriate password.

Authentication credentials of an access point, such as the password of an SSID of an access point, and the SSID itself, may be known to a computing device other than the access point. For example, a subscriber of an internet service provider (ISP) may allow the ISP to provision the access point located in the subscriber's premises such that the ISP is aware of the SSID and password of the access point, or the access point may otherwise communicate such information to the ISP. In such circumstances, it would be convenient for the mobile device to be able to communicate with a computing device of the ISP to obtain the password and SSID to allow the mobile device to authenticate to the access point automatically, without human involvement. However, communicating information that enables a mobile device to automatically authenticate to an access point may create an opportunity for a wrongdoer to obtain the authentication credentials of the access point and join a network, and thus, any such process should ensure that the authentication credentials are communicated only to the appropriate mobile devices to prevent illicit access to the network by a wrongdoer.

The examples disclosed herein implement secure access point authentication credential generation in a mobile device. The mobile device establishes a secure channel with a computing device via encryption. The mobile device receives, from the computing device via the secure channel, encrypted Wi-Fi authentication credentials for a Wi-Fi access point that is associated with the mobile device. The mobile device decrypts the encrypted Wi-Fi authentication credentials to generate decrypted Wi-Fi authentication credentials, and generates, based on the decrypted Wi-Fi authentication credentials, network information to enable the mobile device to authenticate to the Wi-Fi access point without user input and thereby connect to the wireless network.

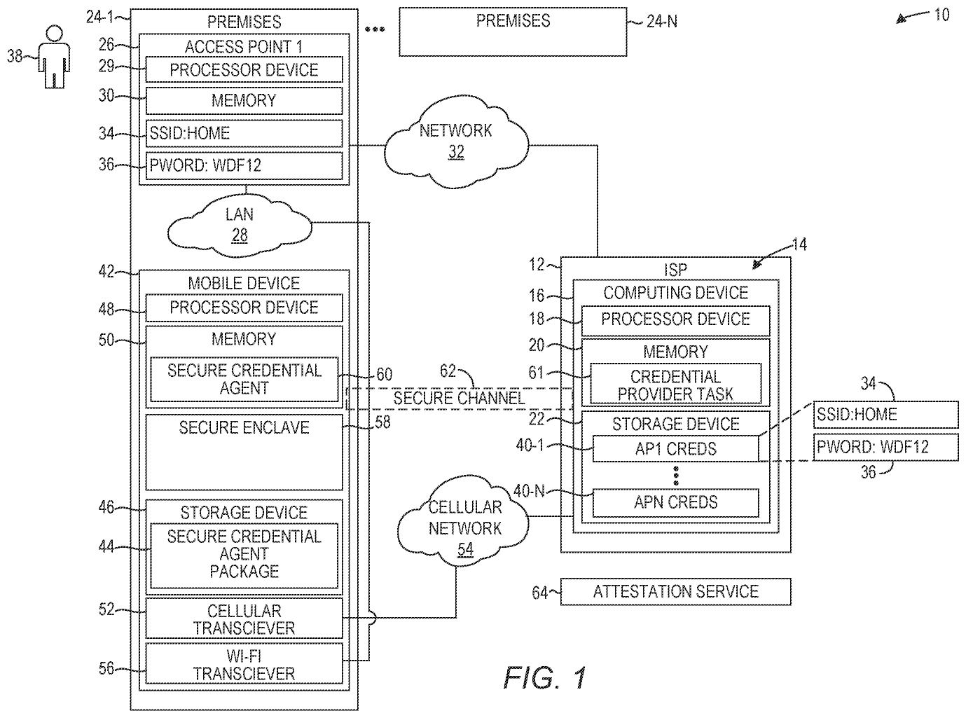

FIG. 1 is a block diagram of a environment 10 in which secure access point authentication credential generation in a mobile device can be practiced according to some examples. The environment 10 includes an Internet Service Provider (ISP) 12 that includes a computing system 14 that includes one or more computing devices 16. Solely for purposes of illustration and space only one computing device 16 is illustrated, however, the functionality attributed to the computing device 16 herein may in practice be distributed across any number of computing devices 16 in the computing system 14.

The computing device 16 includes a processor device 18 and a memory 20. The computing device 16 includes, or is communicatively coupled to, a storage device 22. The ISP 12 provides broadband access (e.g., Internet access), to a plurality of premises 24-1-24-N. Again, solely for purposes of illustration and space only one premises 24-1 is illustrated in detail however, in practice, the ISP may provide broadband access to tens, thousands, or millions of different premises 24.

The premises 24-1 includes an access point 26 that implements a local area network (LAN) 28. The access point 26 includes a processor device 29 and a memory 30. The access point 26 may include or be coupled to a gateway router that provides typical gateway router functionality, such as DHCP services, DNS services, and the like. The access point 26 communicates with the computing system 14 via a network 32 which may comprise, for example, a modem (e.g., a cable or fiber modem, typically located in or near the premises 24-1), an aggregation device such as a fiber node or cable modem termination system, and any other suitable networking apparatus for establishing a communications path between the access point 26 and the computing system 14.

The access point 26 implements a Service Set Identifier (SSID) 34 “HOME” which is the name of the LAN 28. Mobile devices that have the appropriate authentication credentials for the SSID 34, such as an appropriate SSID password 36 (e.g., “WDF12”), can authenticate to the access point 26 and thereby connect to the LAN 28. As used herein, the phrase “authenticating to” or “authenticating with” the access point 26 refers to providing the access point 26 information that indicates a desire to join the LAN 28 and that includes the password 36. The information may include both the SSID 34 and the password 36. Once authenticated, the authenticated device can be referred to as being connected to the access point 26 or as being connected to the LAN 28. Once connected to the access point 26, the authenticated device has broadband access via the ISP 12.

In this example, the ISP 12 provides the access point 26 to a subscriber 38 associated with the premises 24-1 and manages the access point 26 for the convenience of the subscriber 38 and to facilitate problem diagnoses and resolution by the ISP 12. The ISP 12 maintains access point credentials 40-1-40-N, each of which may correspond to a different premises 24-1. The access point credentials 40-1 corresponds to the access point 26 and includes the SSID 34 and the password 36.

In this example, the ISP 12 also offers mobile devices for sale. The subscriber 38 purchases a mobile device 42. Before providing the mobile device 42 to the subscriber 38, the ISP 12 installs a secure credential agent package 44 in a storage device 46 of the mobile device 42. Even though the SSID 34 and the password 36 are known to the ISP 12, the ISP 12 does not provision the mobile device 42 with the SSID 34 or the password 36, and thus the mobile device 42 cannot automatically authenticate to the access point 26 to thereby connect to the LAN 28. The ISP 12 stores information, such as subscriber information, such that the ISP is aware that the access point 26 is associated with the mobile device 42.

The mobile device 42 includes a processor device 48, a memory 50, the storage device 46, and a cellular transceiver 52 that is operable to communicate with a cellular network 54 via a cellular technology, such as 4G cellular technology, 5G cellular technology, or the like. The mobile device 42 also includes a Wi-Fi transceiver 56 that is operable to communicate with a wireless network. In some implementations the mobile device 42 also includes a secure enclave 58 that establishes a secure area within the mobile device 42 that cannot be accessed by the operating system of the mobile device 42, or by any processes executing in the operating system of the mobile device 42.

The implementation of the secure enclave may differ depending on the manufacturer of the mobile device 42. If the mobile device is an Apple® mobile device, such as an iPhone®, iPad®, Apple Watch®, MacBook® or the like, the secure enclave is implemented via a dedicated secure subsystem that includes a processor device separate from the processor device 48, has a boot ROM that is separate from a boot ROM of the processor device 48, and a separate operating system. Secure enclaves are often referred to as Trusted Execution Environments (TEEs). The Android operating system implements a secure enclave referred to as a Trusty TEE. Each secure enclave, irrespective of manufacturer implementation, is an isolated execution environment that provides security features such as isolated execution, integrity of applications executing within the secure enclave, along with confidentiality of assets in the secure enclave. Processes executing in the primary operating system may interact with a secure enclave via a predetermined interface, such as an application programming interface (API), and may request certain secure functions, such as the generation of a public/private key pair, that data be encrypted via the private key, and the like, via such interface.

The mobile device 42 is provisioned by the ISP 12 such that at some point during the initialization stage of the mobile device 42, the mobile device 42 runs the secure credential agent package 44. The execution of the secure credential agent package 44 may be initiated automatically. The term “automatically” as used herein means that an event occurs in the absence of direct user input to cause the event to occur. In one implementation, the execution of the secure credential agent package 44 results in a secure credential task 60 that executes in the memory 50. In some implementations, the secure credential task 60 interfaces with a secure enclave 58 to implement certain of the secure functions disclosed herein. In implementations where the mobile device 42 does not include a secure enclave, the secure credential task 60 may instead implement the secure functions described herein as being implemented by the secure enclave 58.

With this background an example of secure access point authentication credential generation in the mobile device 42 will be described. A more detailed example of secure access point authentication credential generation in the mobile device 42 with reference to the secure credential agent 60 will be discussed below.

The secure credential task 60 communicates with a credential provider task 61 that executes in the memory 20 to establish a secure channel 62 protected via encryption with the computing system 14. Because the mobile device 42 does not yet have the authentication credentials of the access point 26, and in some circumstances, may not even be within wireless range of the access point 26, the mobile device 42 may establish the secure channel 62 at least in part via the cellular network 54. In some implementations, the secure credential task 60 may be pre-provisioned with the address of the computing device 16, such as with the IP address or DNS name of the computing device 16, and upon execution, engage in a sequence of exchanges with the computing device 16 to establish the secure channel with the computing device 16. The phrase “secure channel” as used herein refers to a logical communication path that the computing device 16 and the mobile device 42 have established to send encrypted data that can only be decrypted with corresponding decryption keys over the secure channel 62. Certain mechanisms for establishing the secure channel 62 are described below. In some implementations, as will be described in greater detail below, as part of establishing the secure channel 62, the mobile device 42 and the computing system 14 may utilize an attestation service 64 to validate that the mobile device 42 is in fact the actual mobile device 42 that was sold to the subscriber 38 and that is associated with the access point 26.

After establishing the secure channel 62, the mobile device 42 receives from the credential provider task 61 via the secure channel 62, encrypted Wi-Fi credentials 40-1 for the access point 26. The encrypted credentials include the authentication password 36 and the SSID 34. The mobile device 42 decrypts the encrypted Wi-Fi authentication credentials to generate decrypted Wi-Fi authentication credentials. The mobile device 42, based on the decrypted Wi-Fi authentication credentials, generates network information to enable the mobile device 42 to authenticate to the Wi-Fi access point 26 without user input and thereby connect to the LAN 28. The network information generated may differ depending on the particular manufacturer of the mobile device 42 and/or the particular operating system of the mobile device 42. Generally, the generation of the network information involves generating information that identifies the SSID 34 and the password 36 such that the mobile device 42 can automatically authenticate with the access point 26 automatically in the same manner that a mobile device automatically authenticates with an access point after an initial authentication action where the user selects the appropriate SSID and enters the appropriate password via the display of the mobile device. In this manner the mobile device 42 can automatically, without user input, securely obtain the authentication credentials necessary to authenticate to the access point 26 and connect to the LAN 28.

It is noted that, because the secure credential task 60 is a component of the mobile device 42, functionality implemented by the secure credential task 60 may be attributed to the mobile device 42 generally. Moreover, in examples where the secure credential task 60 comprises software instructions that program the processor device 48 to carry out functionality discussed herein, functionality implemented by the secure credential task 60 may be attributed at least in part to the processor device 48.

Similarly, it is noted that, because the credential provider task 61 is a component of the computing system 14, functionality implemented by the credential provider task 61 may be attributed to the computing system 14 generally. Moreover, in examples where the credential provider task 61 comprises software instructions that program the processor device 18 to carry out functionality discussed herein, functionality implemented by the credential provider task 61 may be attributed at least in part to the processor device 18.

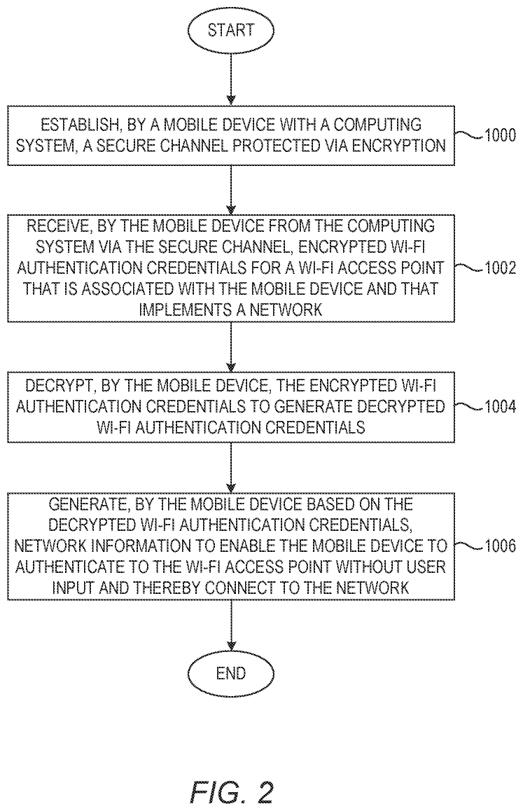

FIG. 2 is a flowchart of a method for secure access point authentication credential generation in a mobile device according to some examples. FIG. 2 will be discussed in conjunction with FIG. 1. The mobile device 42 establishes with the computing system 14 the secure channel 62 protected via encryption (FIG. 2, block 1000). The mobile device 42 receives, from the computing system 14 via the secure channel 62 encrypted the Wi-Fi authentication credentials 40-1 for the Wi-Fi access point 26 that is associated with the mobile device 42 and that implements the network 28 (FIG. 2, block 1002). The mobile device 42 decrypts the encrypted Wi-Fi authentication credentials 40-1 to generate decrypted Wi-Fi authentication credentials (FIG. 2, block 1004). The mobile device 42 generates, based on the decrypted Wi-Fi authentication credentials, network information to enable the mobile device 42 to authenticate to the Wi-Fi access point 26 without user input and thereby connect to the network 28 (FIG. 2, block 1006).

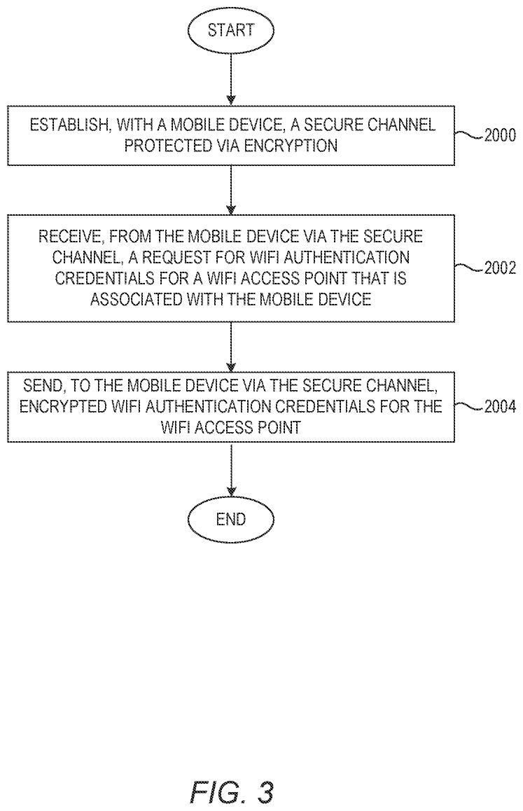

FIG. 3 is a flowchart of a method for secure access point authentication credential generation in a mobile device from the perspective of a computing system according to some examples. FIG. 3 will be discussed in conjunction with FIG. 1. The credential provider task 61 establishes with the mobile device 42 the secure channel 62 protected via encryption (FIG. 3, block 2000). The credential provider task 61 receives, from the mobile device 42 via the secure channel 62, a request for Wi-Fi authentication credentials for the Wi-Fi access point 26 that is associated with the mobile device 42 (FIG. 3, block 2002). The credential provider task 61 sends, to the mobile device 42 via the secure channel 62, the encrypted Wi-Fi authentication credentials 40-1 for the Wi-Fi access point 26 (FIG. 3, block 2004).

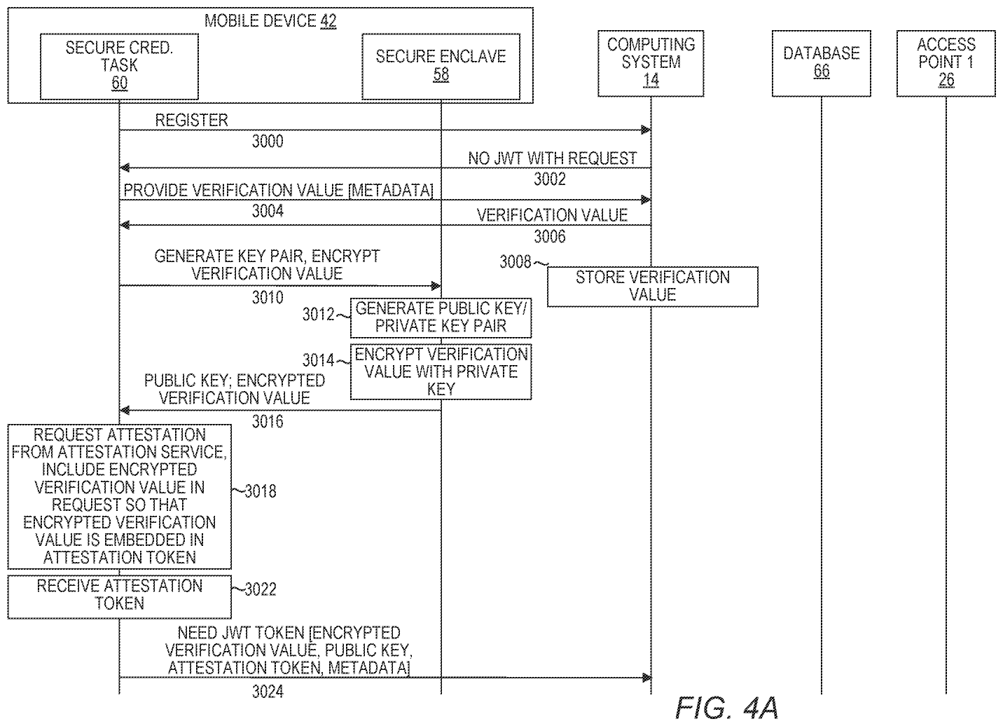

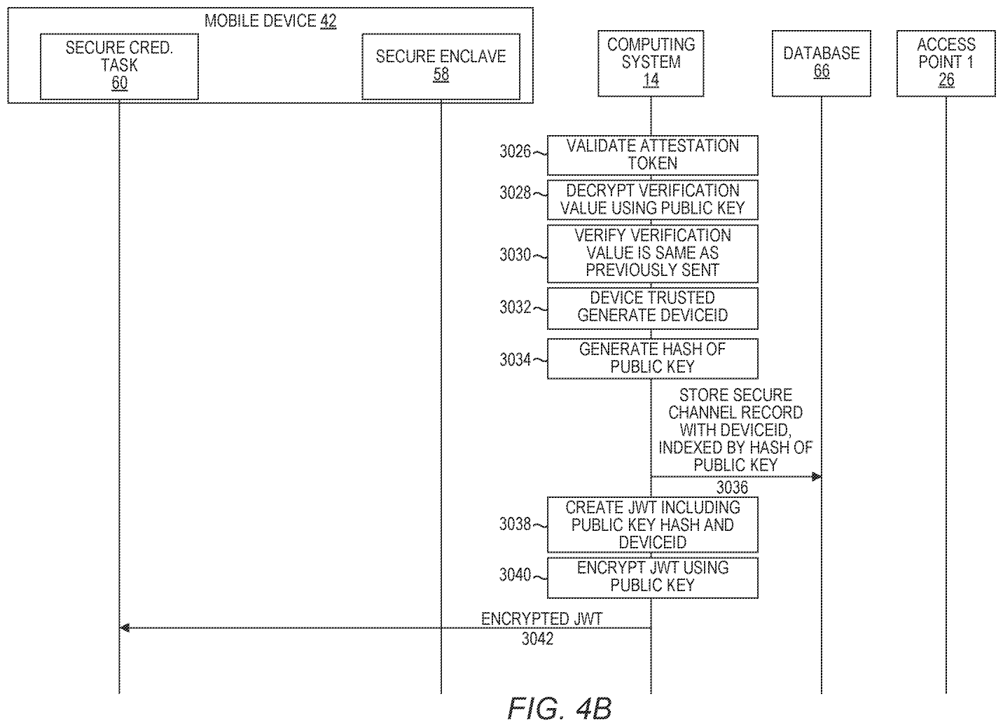

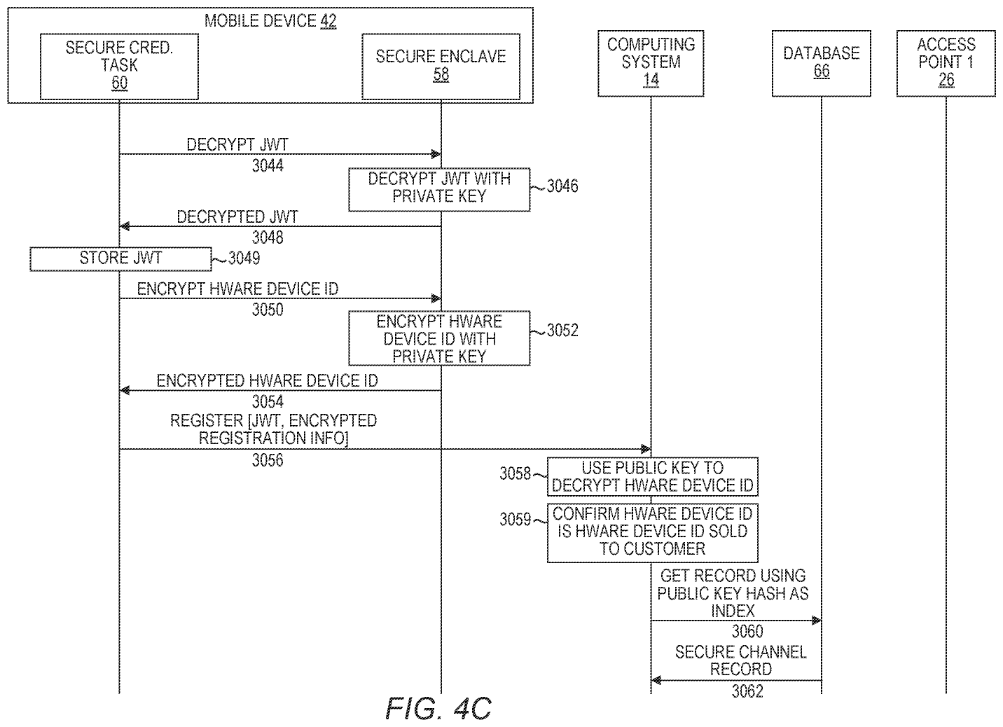

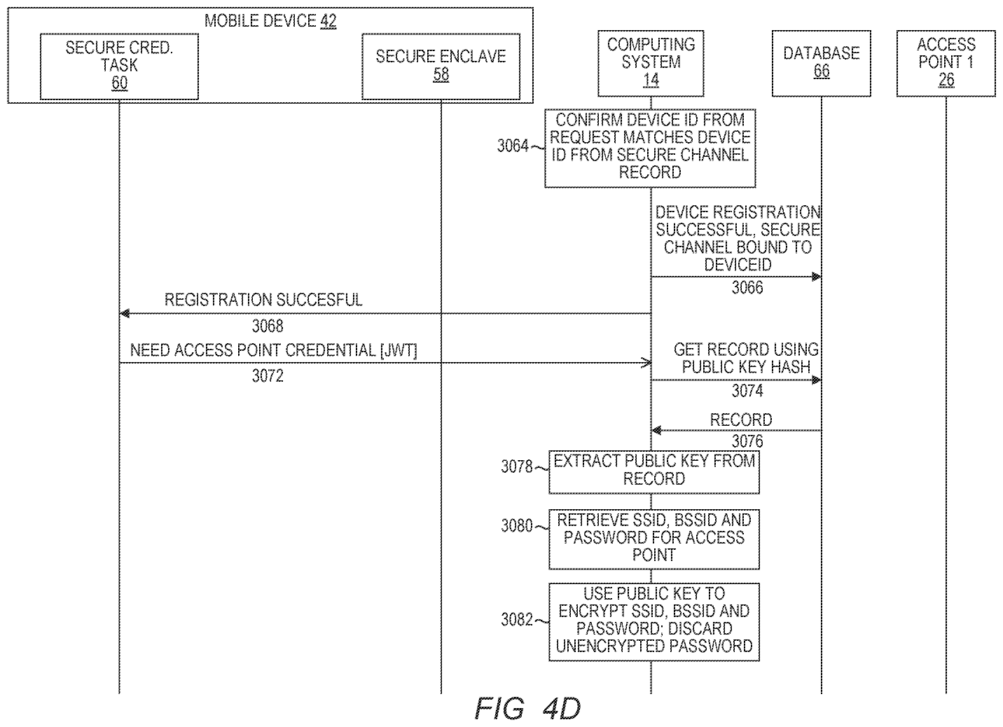

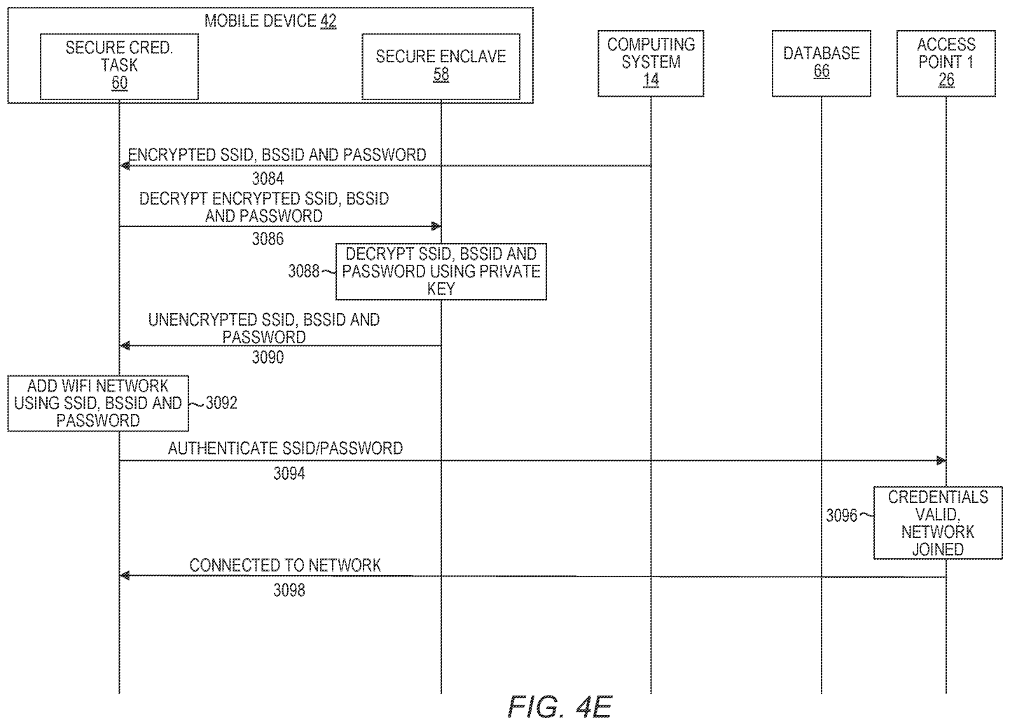

FIGS. 4A-4E are sequence diagrams illustrating messages communicated between and actions taken by components illustrated in FIG. 1 to implement secure access point authentication credential generation in a mobile device according to some examples. In this implementation the secure credential task 60 executing on the mobile device 42 executes in the primary operating system (OS) of the mobile device 42, such as the Android® OS, the Apple® iOS OS, or the like, and communicates, such as via an API, with the secure enclave 58. Depending on the implementation of the secure enclave 58, the secure enclave 58 may execute in a separate OS and may execute via a secure enclave processor device that is different from the processor device 48.

The secure credential task 60 may be provisioned by the ISP 12 to execute upon startup of the mobile device 42 in the background such that the subscriber 38 may be unaware of the execution of the secure credential task 60. The secure credential task 60 may be provisioned by the ISP 12 with an address of the computing system 14. The secure credential task 60 may determine that there is no Wi-Fi network established on the mobile device 42 and thus may utilize the cellular network 54 for communications initially. The secure credential task 60 may initially determine that the secure channel 62 has not yet been established between the mobile device 42 and the computing system 14. This may be determined, for example, by the lack of information in the storage device 46 that would exist if the secure channel 62 had been established.

The secure credential task 60 initially sends a registration message to the computing system 14 (step 3000). The registration message may be any suitable message known to the secure credential task 60 and the credential provider task 61 to be an initial registration message. The computing system 14 determines that the registration message lacks a JSON Web Token (JWT) and in response sends a message, such as, by way of non-limiting example, a status 403 message, that indicates that the registration message is incomplete (step 3002).

In response, the secure credential task 60 sends a request to the computing system 14 to obtain a verification value, sometimes referred to as a nonce (step 3004). The request may, in some implementations, be issued via a HTTP POST method. The request may include metadata, such as an operating system identifier (ID) that identifies the primary OS of the mobile device 42 and an application ID that identifies the secure credential task 60. The computing system 14 receives the request and verifies that the operating system ID and application ID are suitable, and sends a message to the secure credential task 60 with a verification value (step 3006). The verification value may, for example, be a random number or alphanumeric string generated by the computing system 14. The computing system 14 stores the verification value for later use (step 3008). The secure credential task 60 sends a request that includes the verification value to the secure enclave 58 to generate a public key/private key pair, to send the public key to the secure credential task 60, and to encrypt the verification value with the private key (step 3010). The secure enclave 58 generates a public key/private key pair, encrypts the verification value with the private key to generate an encrypted verification value, and sends the public key and the encrypted verification value to the secure credential task 60 (steps 3012, 3014, 3016). The private key does not leave the secure enclave 58.

The secure credential task 60 cause an attestation to occur via an attestation service (step 3018). The secure enclave 58 communicates with a predetermined attestation service to obtain an attestation token (step 3020). The communication includes the encrypted verification value which will be included in the attestation token. Any suitable attestation service may be used. In one implementation, the attestation service is the Google® Play Integrity attestation service. The secure enclave 58 receives an attestation token from the attestation service and sends the attestation token to the secure credential task 60 (step 3022). The attestation token uniquely identifies the mobile device 42.

The secure credential task 60 sends a request to the computing system 14 to obtain a JWT (step 3024-1). The request includes the attestation token, the encrypted verification value, the public key, and may include additional information such as the OS ID that identifies the primary OS of the mobile device 42 and the application ID that identifies the secure credential task 60. In some implementations, the request may be issued via a HTTP POST method.

Referring now to FIG. 4B, the computing system 14 communicates with the attestation service using the attestation token received from the mobile device 42. The computing system 14 determines based on information received from the attestation service that the attestation token is valid (step 3026). The computing system 14 decrypts the verification value using the public key (step 3028). The computing system 14 accesses the previously stored verification value and determines that the decrypted verification value is the same as the previously stored verification value (step 3030). In response to the computing system 14 determining that the device can be trusted, the computing system 14 generates a device ID, such as a globally unique ID (step 3032).

The computing system 14 generates a hash of the public key received from the mobile device 42 (step 3034). The computing system 14 stores in a data store, such as a database 66, a record that corresponds to the mobile device 42 that contains the device ID and is indexed by the hash of the public key (step 3036). The computing system 14 creates a JWT and includes in the JWT the public key hash and the device ID (step 3038). The computing system 14 encrypts the JWT using the public key (step 3040). The computing system 14 sends the encrypted JWT to the mobile device 42 (step 3042).

Referring now to FIG. 4C, the secure credential task 60 receives the encrypted JWT and sends the encrypted JWT to the secure enclave 58 in the secure enclave 58 to be decrypted with the private key (step 3044). The secure enclave 58 decrypts the encrypted JWT using the private key and sends the decrypted JWT to the secure credential task 60 (steps 3046, 3048). The secure enclave 58 stores the JWT in the storage device 46 (step 3049). The secure credential task 60 sends a hardware device ID of the mobile device 42 to the secure enclave 58 to be encrypted (step 3050). The hardware device ID may comprise any unique ID that is associated with the mobile device 42 and known to the computing system 14, such as, by way of non-limiting example, the IMEI (International Mobile Equipment Identity) of the mobile device 42, the MDN (mobile directory number) mobile device 42 or the IMSE (International mobile subscriber identity) of the mobile device 42.

The secure enclave 58 encrypts the hardware device ID using the private key and sends the encrypted hardware device ID to the secure credential task 60 (steps 3052, 3054).

The secure credential task 60 reattempts registration using the JWT and the encrypted hardware device ID (step 3056). The JWT includes the hashed public key. The computing system 14 decrypts the hardware device ID using the public key and confirms that the hardware device ID is the hardware device ID of the mobile device 42 sold to the subscriber 38 (steps 3058, 30596).

The computing system 14 uses the public hash in the JWT to access the previously stored record in the database 66 (step 3058, 3060, 3062). Referring now to FIG. 4D, the computing system 14 confirms that the previously stored record corresponds to the mobile device 42 by confirming that the device ID stored in the record matches the device ID from the request (step 3064). The computing system 14 stores information in the database 66 indicating that the secure channel 62 with the mobile device 42 has been successfully established (step 3066). The computing system 14 sends an acknowledgement to the mobile device 42 indicating that the secure channel 62 has been successfully established (step 3068).

The mobile device 42 may subsequently utilize the JWT to engage in secure communications with the computing system 14. In this example, the mobile device 42 sends a request that includes the JWT to the computing system 14 for the authentication credentials of the access point 26 (step 3072). The computing system 14 receives the JWT and extracts the public key hash from the JWT. The computing system 14 utilizes the public key hash to retrieve the record that corresponds to the mobile device 42 (steps 3074, 3076). The computing system 14 extracts the public key from the record (step 3078).

The computing system 14 accesses the authentication credentials 40-1 that correspond to the access point 26 (step 3080). The computing system 14 uses the public key to encrypt the authentication credentials 40-1, and discards the password (e.g., PSK) (step 3082). Referring now to FIG. 4E, the computing system 14 sends the encrypted authentication credentials to the mobile device 42 (step 3084). The secure credential task 60 receives the encrypted authentication credentials and sends the encrypted authentication credentials to the secure enclave 58 in the secure enclave 58 to be decrypted with the private key (step 3086). The secure enclave 58 decrypts the encrypted authentication credentials using the private key and sends the decrypted authentication credentials to the secure credential task 60 (steps 3088, 3090). The mobile device 42 adds a new network to the mobile device 42 using the SSID, BSSID and the password (step 3092). The access point 26 may broadcast the SSID or may not broadcast the SSID. The mobile device 42 then, automatically (i.e., without human involvement), attempts to authenticate with the access point 26 to thereby join the LAN 28 (step 3094). The access point 26 determines that the credentials are valid, and informs the mobile device 42 that the mobile device 42 has successfully connected to the LAN 28 (steps 3096, 3098).

In another implementation, the mobile device 42 may be provided to the subscriber 38 without the secure credential agent package 44 pre-installed on the mobile device 42. The mobile device 42 may, as part of the initialization of the mobile device 42, communicate with the computing system 14. The computing system 14 may determine that the mobile device 42 does not have the secure credential agent package 44 installed, and may push (i.e., send) the secure credential agent package 44 to the mobile device 42. The mobile device 42 may then initiate the secure credential task 60 from the secure credential agent package 44, and may then obtain the authentication credentials for the access point 26 as described above.

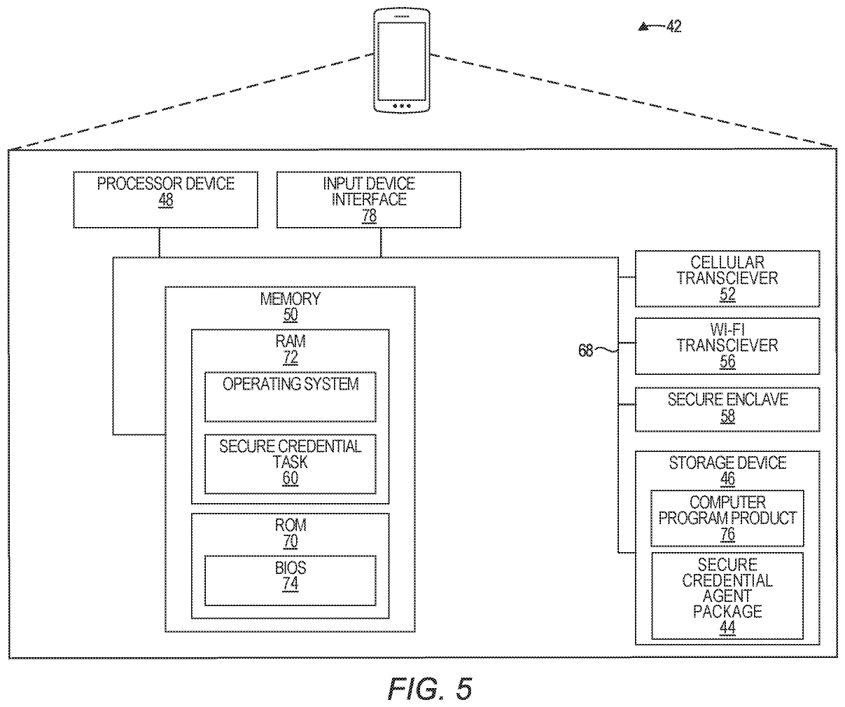

FIG. 5 is a block diagram of the mobile device 42 suitable for implementing examples according to one example. The mobile device 42 may comprise any mobile computing or electronic device capable of including firmware, hardware, and/or executing software instructions to implement the functionality described herein, such as a laptop computing device, a smartphone, a computing tablet, or the like. The mobile device 42 includes the processor device 48, the system memory 50, and a system bus 68. The system bus 68 provides an interface for system components including, but not limited to, the system memory 50 and the processor device 48. The processor device 48 can be any commercially available or proprietary processor.

The system bus 68 may be any of several types of bus structures that may further interconnect to a memory bus (with or without a memory controller), a peripheral bus, and/or a local bus using any of a variety of commercially available bus architectures. The system memory 50 may include non-volatile memory 70 (e.g., read-only memory (ROM), erasable programmable read-only memory (EPROM), electrically erasable programmable read-only memory (EEPROM), etc.), and volatile memory 72 (e.g., random-access memory (RAM)). A basic input/output system (BIOS) 74 may be stored in the non-volatile memory 70 and can include the basic routines that help to transfer information between elements within the mobile device 42. The volatile memory 72 may also include a high-speed RAM, such as static RAM, for caching data.

The mobile device 42 may further include a non-transitory computer-readable storage medium such as the storage device 46, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 46 and other drives associated with computer-readable media and computer-usable media may provide non-volatile storage of data, data structures, computer-executable instructions, and the like.

A number of modules can be stored in the storage device 46 and in the volatile memory 72, including an operating system and one or more program modules, such as the secure credential task 60, which may implement the functionality described herein in whole or in part. All or a portion of the examples may be implemented as a computer program product 76 stored on a transitory or non-transitory computer-usable or computer-readable storage medium, such as the storage device 46, which includes complex programming instructions, such as complex computer-readable program code, to cause the processor device 48 to carry out the steps described herein. Thus, the computer-readable program code can comprise software instructions for implementing the functionality of the examples described herein when executed on the processor device 48. The processor device 48, in conjunction with the secure credential task 60 in the volatile memory 72, may serve as a controller, or control system, for the mobile device 42 that is to implement the functionality described herein.

The subscriber 38 may also be able to enter one or more configuration commands through a software-implemented keyboard (not illustrated) or a touch-sensitive surface such as a display device. Such input devices may be connected to the processor device 48 through an input device interface 78 that is coupled to the system bus 68 but can be connected by other interfaces such as a parallel port, an Institute of Electrical and Electronic Engineers (IEEE) 1394 serial port, a Universal Serial Bus (USB) port, an IR interface, and the like.

Individuals will recognize improvements and modifications to the preferred examples of the disclosure. All such improvements and modifications are considered within the scope of the concepts disclosed herein and the claims that follow.

What is claimed is:

1. A method, comprising;
establishing, by a mobile device with a computing system, a secure channel protected via encryption;
receiving, by the mobile device from the computing system via the secure channel, encrypted Wi-Fi authentication credentials for a Wi-Fi access point that is associated with the mobile device and that implements a network;
decrypting, by the mobile device, the encrypted Wi-Fi authentication credentials to generate decrypted Wi-Fi authentication credentials; and
generating, by the mobile device based on the decrypted Wi-Fi authentication credentials, network information to enable the mobile device to authenticate to the Wi-Fi access point without user input and thereby connect to the network.

2. The method of claim 1, wherein establishing, by the mobile device with the computing system, the secure channel protected via encryption further comprises establishing, by the mobile device with the computing system via a cellular network, the secure channel protected via encryption.

3. The method of claim 1, wherein receiving, by the mobile device from the computing system, the encrypted Wi-Fi authentication credentials for the Wi-Fi access point further comprises receiving, by the mobile device from the computing system, the encrypted Wi-Fi authentication credentials for the Wi-Fi access point via a cellular network.

4. The method of claim 1, further comprising:
prior to receiving the encrypted Wi-Fi authentication credentials, sending, by the mobile device to the computing system, a public key of a public key/private key pair generated by the mobile device;
subsequent to receiving the encrypted Wi-Fi authentication credentials, decrypting, by the mobile device using a private key of the public key/private key pair, the encrypted Wi-Fi authentication credentials to generate a decrypted service set identifier (SSID) and a decrypted SSID password; and
wherein generating the network information to enable the mobile device to authenticate to the Wi-Fi access point without the user input comprises generating the network information using the decrypted SSID and the decrypted SSID password.

5. The method of claim 1, further comprising:
prior to establishing the secure channel:
receiving, by the mobile device from the computing system, a verification value;
generating, by the mobile device, a public key/private key pair;
encrypting, by the mobile device, the verification value using the private key of the public key/private key pair to generate an encrypted verification value;
sending, by the mobile device to an attestation service, the encrypted verification value and information identifying characteristics of the mobile device;
receiving, by the mobile device from the attestation service, an attestation token that includes the encrypted verification value; and
sending, by the mobile device to the computing system, the attestation token and the public key of the public key/private key pair.

6. The method of claim 5, further comprising:
subsequent to sending the attestation token and the public key:
receiving, by the mobile device from the computing system, a JSON web token that includes a device identifier encrypted with the public key and a public key hash of the public key;
encrypting, by the mobile device, a hardware device ID, the public key hash and the public key with the private key to generate encrypted registration information; and
sending, by the mobile device to the computing system, a registration message that includes the encrypted registration information.

7. The method of claim 6, wherein the hardware device ID, the public key hash and the public key JSON are encrypted using the private key in a secure enclave.

8. The method of claim 5, wherein generating the public key/private key pair comprises generating, by the mobile device in a secure enclave of the mobile device, the public key/private key pair, the secure enclave having a secure operating system that is separate from an operating system of the mobile device.

9. The method of claim 8, wherein the encrypted verification value is encrypted using the private key in the secure enclave.

10. The method of claim 8, further comprising obtaining, by a processor device of the mobile device from the secure enclave, the public key, and wherein the private key is inaccessible to the processor device.

11. The method of claim 1, further comprising:
authenticating, by the mobile device, with the Wi-Fi access point using the network information; and
connecting to the Wi-Fi access point.

12. A mobile device, comprising:
a memory;
a processor device communicatively coupled to the memory and operable to:
establish, with a computing system, a secure channel protected via encryption;
receive, from the computing system via the secure channel, encrypted Wi-Fi authentication credentials for a Wi-Fi access point that is associated with the mobile device;
decrypt the encrypted Wi-Fi authentication credentials to generate decrypted Wi-Fi authentication credentials; and
generate, based on the decrypted Wi-Fi authentication credentials, network information to enable the mobile device to authenticate to the Wi-Fi access point without user input and thereby connect to the Wi-Fi access point.

13. The mobile device of claim 12, wherein to establish, with the computing system, the secure channel protected via encryption, the processor device is further operable to establish, with the computing system via a cellular network, the secure channel protected via encryption.

14. The mobile device of claim 12, wherein to receive, from the computing system, the encrypted Wi-Fi authentication credentials for the Wi-Fi access point, the processor device is further operable to receive, from the computing system, the encrypted Wi-Fi authentication credentials for the Wi-Fi access point via a cellular network.

15. The mobile device of claim 12, wherein the processor device is further operable to:
prior to receiving the encrypted Wi-Fi authentication credentials, send, to the computing system, a public key of a public key/private key pair generated by the mobile device;
subsequent to receiving the encrypted Wi-Fi authentication credentials, decrypt, using a private key of the public key/private key pair, the Wi-Fi authentication credentials to generate a decrypted service set identifier (SSID) and a decrypted SSID password; and
wherein to generate the network information to enable the mobile device to authenticate to the Wi-Fi access point without the user input, the processor device is further operable to generate the network information using the decrypted SSID and the decrypted SSID password.

16. A computing system, comprising:
one or more computing devices operable to:
establish, with a mobile device, a secure channel protected via encryption;
receive, from the mobile device via the secure channel, a request for Wi-Fi authentication credentials for a Wi-Fi access point that is associated with the mobile device; and
send, to the mobile device via the secure channel, encrypted Wi-Fi authentication credentials for the Wi-Fi access point.

17. The computing system of claim 16 wherein the one or more computing devices are further operable to:
receive, from the mobile device, a public key;
send, to the mobile device, a device identifier;
receive, from the mobile device, a registration message that includes an encrypted device identifier;
decrypt, using the public key, the registration message to generate a decrypted device identifier;
determine that the decrypted device identifier matches the device identifier previously sent to the mobile device; and
wherein the encrypted Wi-Fi authentication credentials for the Wi-Fi access point are sent to the mobile device in response to the decrypted identifier matching the device identifier previously sent to the mobile device.

18. The computing system of claim 17 wherein the one or more computing devices are further operable to:
receive, from the mobile device, an attestation token obtained from an attestation service;
validate the attestation token; and
in response to validating the attestation token:
generate a JSON web token that includes the device identifier; and
send the JSON web token to the mobile device.

19. The computing system of claim 16 wherein the one or more computing devices are further operable to:
prior to establishing the secure channel protected via encryption, send, to the mobile device, a verification value;
receive, from the mobile device, an encrypted verification value and a public key;
decrypt the encrypted verification value using the public key to generate a decrypted verification value; and
determine that the decrypted verification value matches the verification value.

20. The computing system of claim 16, wherein to establish, with the mobile device, the secure channel protected via encryption, the one or more computing devices are further operable to establish, with the mobile device via a cellular network, the secure channel protected via encryption.
